(19) United States
(12) Patent Application Publication
(10) Pub. No.: US 2024/0240792 A1
(43) Pub. Date: Jul. 18, 2024

(54) COMBUSTOR AND COMBUSTION NOZZLE THEREOF FOR HYDROGEN GAS TURBINE

(71) Applicant: TOYOTA JIDOSHA KABUSHIKI KAISHA, Toyota-shi (JP)

(72) Inventors: Yasushi TATEBAYASHI, Fuji-shi (JP); Shigeru HIRANO, Mishima-shi (JP)

(73) Assignee: TOYOTA JIDOSHA KABUSHIKI KAISHA, Toyota-shi (JP)

(21) Appl. No.: 18/387,667

(22) Filed: Nov. 7, 2023

(30) Foreign Application Priority Data
Jan. 18, 2023 (JP) 2023-006170

(51) Int. Cl. F23R 3/28; F02C 7/22; F23R 3/10

(52) U.S. Cl. CPC F23R 3/28; F02C 7/22; F23R 3/10

(57) ABSTRACT

A combustion nozzle injects compressed air and fuel for combustion into a combustion chamber of a combustor for a gas turbine. The combustion nozzle includes a first air injection hole through which a first air flow of the compressed air is injected into the combustion chamber, a second air injection hole through which a second air flow of the compressed air is injected adjacent to the first air flow into the combustion chamber, and a fuel injection hole through which a fuel flow of the fuel is injected into the combustion chamber at a flow velocity different from a flow velocity of the first air flow and a flow velocity of the second air flow in a state where the fuel flow is sandwiched between the first air flow and the second air flow. The fuel injection hole has an inner diameter smaller than a quenching distance of the fuel.

### CROSS-REFERENCE TO RELATED APPLICATION

This application claims priority to Japanese Patent Application No. 2023-006170 filed on Jan. 18, 2023, incorporated herein by reference in its entirety.

### BACKGROUND

### 1. Technical Field

The disclosure relates to a combustor for a gas turbine engine (hereinafter referred to as “gas turbine”), and a nozzle configured to inject compressed air and fuel into a combustion chamber of the combustor for combustion, i.e., a combustion nozzle, and more particularly to a combustor and a combustion nozzle thereof suitable for a gas turbine capable of using hydrogen as fuel, i.e., a hydrogen gas turbine.

### 2. Description of Related Art

From a viewpoint of global warming prevention and decarbonization, research and development of heat engines, such as a gas turbine, using hydrogen as fuel have been advanced. For example, Japanese Unexamined Patent Application Publication No. 2016-109309 (JP 2016-109309 A) proposes a configuration of a combustor for a gas turbine using hydrogen and methane as fuel. The combustor includes a main burner of a premix combustion type disposed upstream of a combustion cylinder that forms a combustion chamber, and a plurality of reheating burners of a diffusion combustion type. The main burner is configured to inject methane as main fuel, and the reheating burners are configured to inject fuel from a peripheral wall of the combustion cylinder into a combustion field in the combustion chamber. Some of the reheating burners are configured to inject hydrogen. With such a configuration, since the main burner is of the premix combustion type, it is possible to reduce the amount of nitrogen oxide (NOx) contained in high-temperature combustion gas generated in a primary combustion zone in an upstream part of the combustion chamber. In addition, in relation to injection volume of hydrogen, arranging the reheating burners apart from one another reduces the fuel concentration in a combustion zone of each of the reheating burners and thus decreases the combustion temperatures of the fuel injected from the reheating burners as a whole, thereby reducing generation of NOx. Furthermore, in the above-described configuration, employment of the reheating burners of the diffusion combustion type reduces a risk of flashback. Japanese Unexamined Patent Application Publication No. 2020-106258 (JP 2020-106258 A) proposes a configuration of a combustor for a gas turbine using high reactive gas such as hydrogen as fuel to achieve low NOx combustion, flashback prevention, and reduction of combustion dynamics. The combustor includes a plurality of annular fuel injection units concentrically arranged on an upstream end surface of a combustion cylinder that forms a combustion chamber. Each of the annular fuel injection units includes an annular fuel injection member having a plurality of fuel injection holes open to an outer peripheral surface and/or an inner peripheral surface of the annular fuel injection member, and an annular air guide member that guides air to fuel gas injected through each of the fuel injection holes of the annular fuel injection member. The combustor includes at least one of (i) a plurality of circumferentially partitioning walls extending in a radial direction and disposed at regular intervals so as to partition gas passages of the annular fuel injection units in a circumferential direction, and (ii) a radially partitioning wall that extends in the circumferential direction and partitions any two adjacent annular fuel injection units in the radial direction. Japanese Unexamined Patent Application Publication No. 2003-148734 (JP 2003-148734 A) proposes a configuration of a gas turbine facility in which fuel and air are supplied to a combustion chamber as a plurality of coaxial jets and an air flow is formed on an outer peripheral side of a flow of fuel flowing at the center in a premixing flow passage, in order to reduce NOx and stabilize flame in the combustion chamber by accelerating mixing of the fuel and the air. In such a configuration, premixing air and fuel allows lean combustion to advantageously achieve low NOx combustion. However, a large space is required to obtain a suitably mixed state of air and fuel, which may increase a risk of flashback, i.e., a phenomenon in which the fuel flows back. To reduce the risk of flashback, the above-described configuration uses a plurality of nozzles to allow combustion to take place in a narrow space in a short time. In the configuration of JP 2003-148734 A, fuel is not limited to hydrogen, but it has been the basic configuration for hydrogen-combustion-related configurations from then on. Japanese Unexamined Patent Application Publication No. 2013-139975 (JP 2013-139975 A) proposes a configuration of a gas turbine combustor that includes a plurality of multi-hole coaxial jet burners having a plurality of air holes arranged concentrically in lines on an upstream side of a combustion chamber and a plurality of fuel nozzles configured to supply fuel from an upstream side of the air holes, a plurality of combustion-chamber sidewall air holes having a discharging direction oriented toward a central axis of the combustion chamber and provided in an upstream sidewall of the combustion chamber, and a plurality of combustion-chamber sidewall coaxial jet burners disposed at predetermined intervals in a circumferential direction of the sidewall of the combustion chamber and having fuel nozzles arranged for supplying fuel coaxially to the air holes, in order to attempt to maintain stable combustion and low NOx combustion performance.

### SUMMARY

When hydrogen is used as fuel for a gas turbine, NOx tends to be generated because the combustion temperature of hydrogen fuel is higher than that of hydrocarbon fuel that has been generally used, and “flashback”, i.e., a phenomenon in which fuel flows back toward an upstream side of a fuel passage, is more likely to occur because the combustion velocity of hydrogen fuel is greater than that of hydrocarbon fuel and the quenching distance of hydrogen fuel, i.e., 0.64 mm, is shorter than that of hydrocarbon fuel, i.e., approximately 2 mm. Therefore, for a configuration of a combustor for a gas turbine using hydrogen as fuel, i.e., a hydrogen gas turbine, challenges are to reduce NOx by suitably mixing fuel and air before combustion to prevent generation of any locally high fuel concentration area because high fuel concentration increases the combustion temperature, and to prevent flashback. In this regard, the above-exemplified configurations of the conventional combustors for the hydrogen gas turbines, which are configured to reduce NOx and prevent flashback, are intended for middle-sized or large-sized gas turbines for power generation, which generate power output of over one megawatt. Such combustors have rather complicated configurations that require a lot of components and large spaces, and it is difficult to apply such a configuration to a combustor for a small-sized gas turbine that generates power output of several tens of kilowatts. It is therefore advantageous to provide a combustion nozzle having a new configuration that is applicable to a combustor for a small-sized gas turbine and that is capable of sufficiently mixing air and hydrogen evenly before combustion while avoiding flashback, and a combustor including the combustion nozzle.

In view of the above circumstances, a main objective of the disclosure is to provide a combustion nozzle having a new configuration suitable for a combustor for a small-sized gas turbine capable of using hydrogen as fuel.

Another objective of the disclosure is to provide a combustion nozzle usable for a combustor for a small-sized gas turbine as described above, and having a new configuration capable of sufficiently mixing air and hydrogen evenly before combustion while avoiding flashback in a small space.

Yet another objective of the disclosure is to provide a combustor for a gas turbine, which is provided with the above-described combustion nozzle.

According to the disclosure, the above-described objectives are achieved by a combustion nozzle configured to inject compressed air and fuel for combustion into a combustion chamber of a combustor for a gas turbine. The combustion nozzle includes a first air injection hole through which a first air flow of the compressed air is injected into the combustion chamber, a second air injection hole through which a second air flow of the compressed air is injected adjacent to the first air flow into the combustion chamber, and a fuel injection hole through which a fuel flow of the fuel is injected into the combustion chamber at a flow velocity different from a flow velocity of the first air flow and a flow velocity of the second air flow in a state where the fuel flow is sandwiched between the first air flow and the second air flow. The fuel injection hole has an inner diameter smaller than a quenching distance of the fuel.

In the above-described configuration, the “combustion nozzle” refers to a nozzle that is configured to mix and inject compressed air and fuel for combustion into the combustion chamber of the combustor for the gas turbine as described above. The combustion nozzle according to the disclosure is configured such that, the air sent to the combustion nozzle after being taken into a compressor from outside and compressed, i.e., the compressed air, is injected through separate injection holes, that is, the “first air injection hole” and the “second air injection hole”, into the combustion chamber as the first air flow and the second air flow that are adjacent to each other. In addition, the “fuel injection hole” through which the fuel is injected is interposed between the “first air injection hole” and the “second air injection hole”, so that the fuel is injected through the “fuel injection hole” as the fuel flow that is sandwiched between the first air flow and the second air flow, at the flow velocity different from those of the first air flow and the second air flow. In such a configuration, since the fuel flow is sandwiched between the first air flow and the second air flow when the compressed air and the fuel are injected into the combustion chamber, the fuel is unlikely to be blown off to any side by any one of the air flows. In addition, shear actions generated between the first air flow and the fuel flow and between the second air flow and the fuel flow allow the fuel flow to be dispersed into the air flows immediately after the air and the fuel are injected through the corresponding injection holes. A simulation result has found out that the fuel flow spins to be dispersed into the air flows at both sides of the fuel flow. In this configuration, the air and the fuel are mixed rapidly and sufficiently without requiring a large space. As a result, generation of a locally high-combustion-temperature zone is suppressed, and generation of NOx is reduced even in a combustor for a small-sized gas turbine. Since the fuel injection hole through which the fuel flow is injected has an inner diameter smaller than the quenching distance of the fuel, the flashback toward the fuel injection hole can be suppressed. The fuel may be hydrogen. In this case, since the quenching distance is approximately 0.64 mm, the inner diameter of the fuel injection hole may be, for example, 0.6 mm or less.

Furthermore, in the above-described configuration according to the disclosure, since the fuel flow injected from a nozzle tip is sandwiched between the first air flow and the second air flow, a risk of melting of the nozzle tip caused by flame is also reduced. This is because the presence of the air flows at both sides of the fuel flow makes it difficult for the fuel flow to stay at the nozzle tip and to flow back to the nozzle tip, thereby keeping the flame apart from the nozzle tip, and the nozzle tip is cooled by the air flows.

Although the above-described combustion nozzle may take any shape, the combustion nozzle may be configured to discharge the fuel and the compressed air into a space as evenly as possible. Therefore, the combustion nozzle may typically have a cylindrical shape, and may be configured to inject the fuel and the compressed air from one end surface of the combustion nozzle. In this case, in order to prevent occurrence of an uneven distribution of the fuel and the compressed air that are injected, a plurality of the fuel injection holes may be disposed at a position circumferentially surrounding the first air injection hole, and the second air injection hole may be disposed at a position circumferentially surrounding the first air injection hole and the fuel injection holes. The first air injection hole may have a substantially circular shape, or a slit shape extending circumferentially. The second air injection hole may be a plurality of holes arranged circumferentially, or may have a slit shape extending circumferentially. Since the fuel injection holes each have an inner diameter smaller than the quenching distance, in general, the fuel injection holes that have a substantially circular shape are arranged circumferentially. However, the fuel injection holes may have a slit shape having a width smaller than the quenching distance. In the case where hydrogen is used as fuel, since hydrogen has an extremely small density compared to other types of fuels, hydrogen has a small inertial force and low momentum when being injected from a hole. If hydrogen is injected through only a single injection hole, the hydrogen is unlikely to be smoothly dispersed into the surroundings. On the other hand, in the above-described configuration in which the fuel injection holes are disposed circumferentially and the fuel is injected therefrom, a contact area between the fuel and the air increases, which accelerates mixing of the fuel and the air. As a result, further reduction in generation of NOx may be expected.

In the above-described configuration of the combustion nozzle according to the disclosure, the first air injection hole and the second air injection hole may be provided such that a flow direction of the first air flow and a flow direction of the second air flow are different from each other. When the flow direction of the first air flow and the flow direction of the second air flow are different from each other, a shear action is generated between the first air flow and the second air flow, so that the fuel in the fuel flow sandwiched between the first air flow and the second air flow is more suitably mixed with the air flows. The configuration in which the flow direction of the first air flow and the flow direction of the second air flow are different from each other may be achieved by any suitable manner. For example, an air flow passage directly communicating with an opening of the first air injection hole and an air flow passage directly communicating with an opening of the second air injection hole may be provided such that the extending directions of the air flow passages intersect with each other, whereby directions of the air flows injected from the first air injection hole and the second air injection hole intersect with each other.

Alternatively, in the above-described configuration of the combustion nozzle according to the disclosure, the first air injection hole and the second air injection hole may be provided so as to make at least one of the first air flow and the second air flow a swirling flow so that the fuel in the fuel flow sandwiched between the first air flow and the second air flow is further more suitably mixed with the air flows by generating shear actions between the first air flow and the second air flow. To make the first air flow or the second air flow a swirling flow may be achieved by any manner. The first air flow may be a swirling flow and the second air flow may be a linear flow, or vice versa. Specifically, the configuration in which the second air flow surrounds the first air flow allows the first air flow to flow swirling around inside the second air flow by causing the second air flow to flow in an axial direction of the combustion nozzle from the nozzle tip and applying, to the first air flow, an air flow component flowing in a circumferential direction of the first air injection hole by any technique. The first air flow may have a flow component that flows in the circumferential direction of the nozzle, for example, by providing a swirler in a passage upstream of the first air injection hole or by providing a compressed air intake passage such that the compressed air flows in along the circumferential direction of an inner periphery of the passage upstream of the first air injection hole. As another aspect, in a configuration in which, at an upstream end of a combustor, a plurality of combustion nozzles configured to cause the second air flow to surround the first air flow is provided such that the combustion nozzles are arranged adjacent to each other, the second air flow may be made a swirling flow by applying, to the second air flow, an air flow component flowing in a circumferential direction of the second air injection hole by any technique.

The above-described combustion nozzle according to the disclosure may include additional air injection holes through which an additional air flow, which is injected from the combustion nozzle in addition to the first air flow and the second air flow, is injected adjacent to the first air flow and the second air flow, and additional fuel injection holes through which an additional fuel flow is injected between the adjacently disposed air flows. For example, when the combustion nozzle has a cylindrical shape and the second air injection holes are disposed so as to surround the first air injection hole along the outer periphery of the first air injection hole, the additional fuel injection holes may be disposed at positions radially outward of the second air injection holes so as to surround the second air injection holes, and the additional air injection holes may be disposed so as to surround the outer periphery of the additional fuel injection holes. More additional fuel injection holes and more additional air injection holes may be provided in this order at positions radially outward of the additional air injection holes in the same manner.

In a combustor for a gas turbine, which includes the above-described combustion nozzle, the compressed air and the fuel are mixed rapidly and sufficiently as soon as the compressed air and the fuel are injected into the combustion chamber, so that generation of NOx may be reduced and flashback may be prevented. Accordingly, the disclosure provides the combustor including the above-described combustion nozzle. In particular, the combustor for a gas turbine according to the disclosure may have a configuration that includes a plurality of combustion nozzles arranged adjacent to each other and configured to inject compressed air and fuel for combustion into a combustion chamber. In this case, each of the combustion nozzles includes a first air injection hole through which a first air flow of the compressed air is injected into the combustion chamber, a second air injection hole through which a second air flow of the compressed air is injected adjacent to the first air flow into the combustion chamber, and a fuel injection hole through which a fuel flow of the fuel is injected into the combustion chamber at a flow velocity different from a flow velocity of the first air flow and a flow velocity of the second air flow in a state where the fuel flow is sandwiched between the first air flow and the second air flow, the fuel injection hole having an inner diameter smaller than a quenching distance of the fuel. The fuel injection hole may be disposed at a position circumferentially surrounding the first air injection hole and the second air injection hole is disposed at a position circumferentially surrounding the first air injection hole and the fuel injection hole. The first air injection hole and the second air injection hole may be provided such that at least one of the first air flow and the second air flow becomes a swirling flow. When at least one of the first air flow and the second air flow becomes a swirling flow at each of the combustion nozzles arranged adjacent to each other, a rotational component is generated in a flow of an air-fuel mixture of the fuel and the compressed air injected from each of the combustion nozzles. In addition, arrangement of the flows of the air-fuel mixture adjacent to each other generates a component that flows in a circumferential direction of the overall combustion chamber. This allows the flow of the air-fuel mixture to be more evenly dispersed and suppresses unevenness in the density of the air-fuel mixture. As a result, generation of NOx may be reduced further.

As described above, the combustion nozzle of the combustor for a gas turbine according to the disclosure allows the fuel to be mixed with the compressed air sufficiently and more evenly within a relatively short distance when the compressed air flow and the fuel flow are discharged into the combustion chamber. This prevents the flashback and reduces generation of NOx even when fuel having a high combustion temperature, such as hydrogen, is used for the combustion. Therefore, the combustion nozzle of the disclosure is applicable to a combustor for a small-sized gas turbine. The combustion nozzle according to the disclosure and the combustor including the combustion nozzle are applicable to a small-sized gas turbine mountable on a vehicle such as a motor vehicle and using hydrogen as fuel. This allows a hydrogen gas turbine to be more widely used.

Other objectives and advantages of the disclosure will become apparent from the following description of embodiments of the disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a combustor for a gas turbine, to which a combustion nozzle according to an embodiment is applied;

FIG. 2A is a schematic view illustrating an end surface of the combustion nozzle on a combustion chamber-side, according to the embodiment;

FIG. 2B is a schematic cross-sectional view of the combustion nozzle, taken along line IIB-IIB of FIG. 2A;

FIG. 2C is a diagram illustrating air flows PA1, PA2 and a fuel flow F that are injected from the end surface of the combustion nozzle into the combustion chamber, as viewed from the side thereof;

FIG. 3A is an example (an example where a compressed air flow PA1 is provided as a swirling flow) of a schematic cross-sectional view taken along line IIIA-IIIA of FIG. 2B;

FIG. 3B is a diagram illustrating the air flows PA1, PA2 and the fuel flow F that are injected into the combustion chamber, as viewed from the side thereof, in a case where the air flow PA1 injected from an air injection hole in a center region of the combustion nozzle is provided as a swirling flow;

FIG. 3C is a schematic view illustrating an example of an end surface of the combustor, the end surface being on an upstream side of the combustion chamber;

FIG. 4A is a schematic view illustrating an end surface of a combustion nozzle on the combustion chamber-side, according to a modification of the embodiment;

FIG. 4B is a schematic view illustrating an end surface of a combustion nozzle on the combustion chamber-side, according to another modification of the embodiment;

FIG. 4C is a schematic view illustrating an end surface of a combustion nozzle on the combustion chamber-side, according to yet another modification of the embodiment;

FIG. 5A is a schematic view illustrating an end surface of a combustion nozzle on the combustion chamber-side, according to a modification of the embodiment; and

FIG. 5B is a schematic cross-sectional view of the combustion nozzle, taken along line VB-VB of FIG. 5A.

### DETAILED DESCRIPTION OF EMBODIMENTS

### Basic Configuration of Combustor and Combustion Nozzle

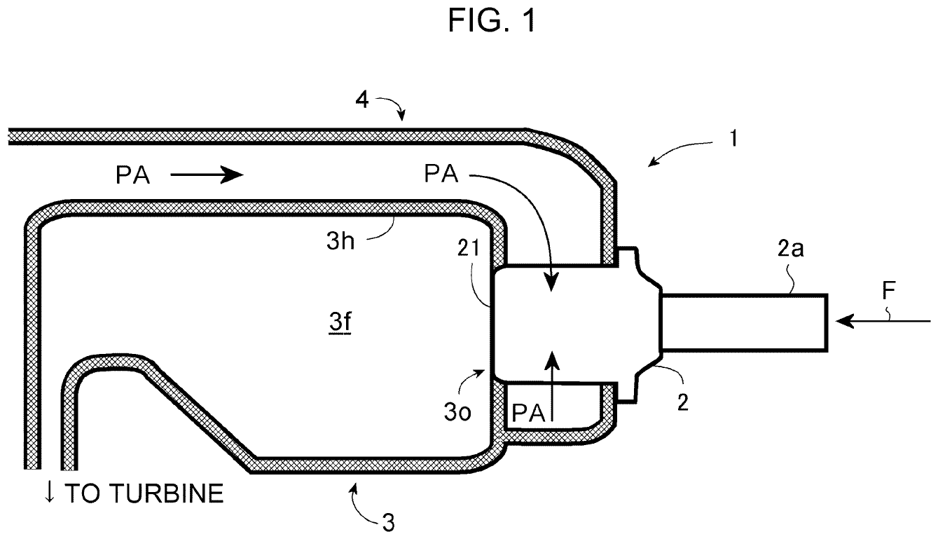

A combustion nozzle according to an embodiment is advantageously used for a combustor for a gas turbine using, as fuels, substances, such as hydrogen, having a lighter mass and a higher combustion temperature than those of conventionally used hydrocarbon-based substances. As illustrated in FIG. 1, a combustor 1 for a gas turbine includes a combustion nozzle 2 disposed at an opening 30 of a housing 3h of a combustion chamber 3 that defines a combustion field 3f. In short, compressed air PA flows into the combustion nozzle 2 from a compressor (not illustrated) connected to the gas turbine (not illustrated) through a compressed air supply ring 4 of a ring shape defined around the outer periphery of the combustion chamber 3, and fuel F flows into the combustion nozzle 2 from a fuel tank (not illustrated) through a fuel supply tube 2a. The compressed air PA and the fuel F are mixed and discharged into the combustion field 3f for combustion.

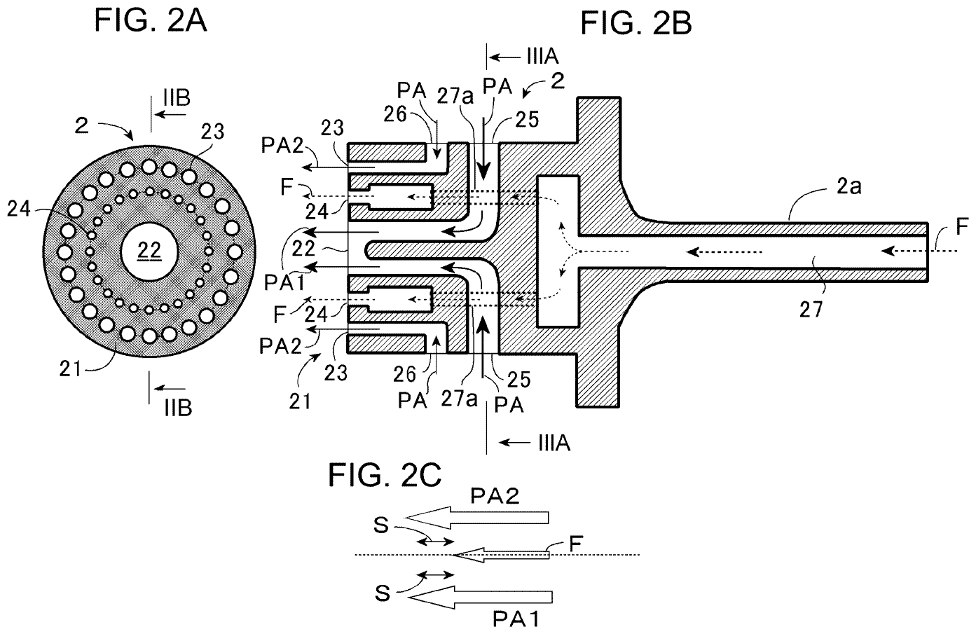

Specifically, the combustion nozzle 2 may have a substantially cylindrical shape as illustrated in FIGS. 2A and 2B, and is fitted into the opening 30 of the housing 3h of the combustion chamber 3 such that a nozzle end surface 21 of the combustion nozzle 2 faces the combustion field 3f. The nozzle end surface 21 of the combustion nozzle 2 may have a first air injection hole 22 open at a generally center region of the nozzle end surface 21, a plurality of second air injection holes 23 disposed so as to surround the first air injection hole 22, and a plurality of fuel injection holes 24 disposed between the first air injection hole 22 and the second air injection holes 23 so as to surround the first air injection hole 22. The first air injection hole 22, the fuel injection holes 24, and the second air injection holes 23 may be concentrically disposed in this order such that the compressed air and the fuel are injected more evenly into a space (the same applies hereafter). As understood from FIG. 2B, a compressed air flow PA1 flowing from the compressed air supply ring 4 through a first air intake hole 25 may be injected from the first air injection hole 22 toward the combustion field 3f, a compressed air flow PA2 flowing from the compressed air supply ring 4 through a second air intake hole 26 may be injected from the second air injection holes 23 toward the combustion field 3f such that the compressed air flow PA2 is adjacent to the compressed air flow PA1, and fuel flowing through fuel flow passages 27, 27a inside the fuel supply tube 2a may be injected from the fuel injection holes 24 toward the combustion field 3f as a fuel flow F. In the above-described configuration, the fuel flow F is sandwiched between the compressed air flow PA1 and the compressed air flow PA2. Since a flow velocity of the fuel flow F and flow velocities of the compressed air flows PA1, PA2 are different from each other in general, shear actions S act on the fuel flow F from both sides thereof, i.e., from the compressed air flow PA1 and the compressed air flow PA2, as illustrated in FIG. 2C. As a result, the fuel flow F is rapidly dispersed into the compressed air flow PA1 and the compressed air flow PA2 without being blown off to one of the compressed air flows PA1, PA2. A simulation result has observed that the fuel flow F spins and spreads into the compressed air flow PA1 and the compressed air flow PA2. In other words, in the above-described configuration, since the fuel flow F is more suitably mixed with the compressed air flows PA1, PA2 immediately after being injected into the combustion field 3f, the fuel is dispersed in the air without requiring a space for premixing the fuel and the air before combustion. As a result, even the size of the combustor is small, the fuel and the air are sufficiently mixed, and generation of NOx may be reduced.

It is noted that, in the above-described configuration, the fuel injection holes 24 are designed to have an inner diameter smaller than a quenching distance of the fuel in order to prevent flashback. Specifically, since the quenching distance of hydrogen is approximately 0.64 mm, the inner diameters of the fuel injection holes 24 may be, for example, 0.6 mm or less when hydrogen is used as fuel.

In addition, in the case where hydrogen is used as fuel, since hydrogen has an extremely small density compared to other types of fuels, hydrogen has a small inertial force and low momentum if the hydrogen is injected through only a single hole. In this case, hydrogen is unlikely to be smoothly dispersed into the compressed air. On the other hand, when the fuel injection holes 24 are circumferentially interposed between the first air injection hole 22 and the second air injection holes 23 as described above, a contact area between the fuel flow F and the compressed air flows PA1, PA2 increases, which accelerates mixing of the fuel and the air even in the case where hydrogen is used as fuel.

As described above, in the configuration where the fuel flow F is sandwiched between the compressed air flow PA1 and the compressed air flow PA2, a flame flow generated from the fuel flow F is less likely to flow back toward the nozzle end surface 21. In addition, since the entire area of a nozzle tip of the combustion nozzle 2 is cooled by the compressed air, the nozzle end surface 21 is protected against a risk of melting caused by the flame flow and overheating.

### Swirling of Compressed Air Flows

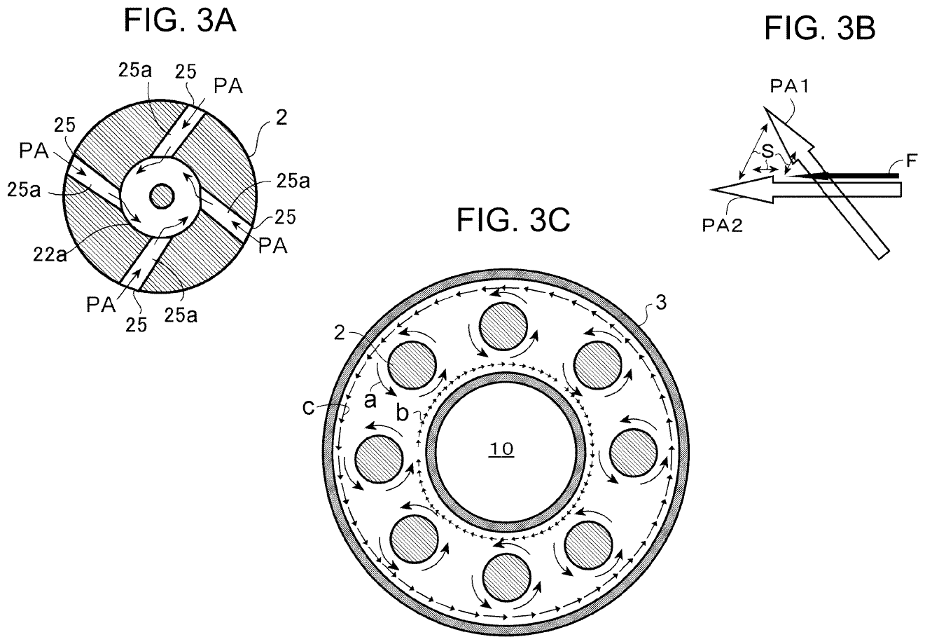

The above-described combustion nozzle may preferably be configured to generate an air flow component proceeding in a circumferential direction of the first air injection hole 22 in an air flow passage extending from the first air intake hole 25 to the first air injection hole 22 or an air flow component proceeding in a circumferential direction of the second air injection holes 23 in an air flow passage extending from the second air intake hole 26 to the second air injection holes 23 such that flow directions of the compressed air flow PA1 and the compressed air flow PA2 intersect with each other or at least one of the compressed air flow PA1 and the compressed air flow PA2 becomes a swirling flow. In the case where the flow directions of the compressed air flow PA1 and the compressed air flow PA2 intersect with each other, shear actions S are also generated between the compressed air flow PA1 and the compressed air flow PA2 as schematically illustrated in FIG. 3B, so that the flows complicatedly intersect with and act on one another, and the shear actions S having different directions act on the fuel flow F. As a result, the air and the fuel may be mixed more rapidly and more sufficiently, and further reduction in generation of NOx may be expected.

In a combustor 1 having an annular shape and including a plurality of combustion nozzles 2 disposed in a circumferential direction of the combustor 1 as schematically illustrated in FIG. 3C, when the compressed air flow PA1 or the compressed air flow PA2 injected from each of the combustion nozzles 2 includes a swirling component a, fluid flows b, c are generated in the circumferential direction of the combustor 1 inside a combustion chamber 3 of the combustor 1. As a result, an air-fuel mixture of the fuel and the compressed air is distributed more evenly in the entire combustion chamber 3, and further reduction in generation of NOx may be expected.

Swirling of the compressed air flow PA1 or PA2 may be achieved by any technique. To make the compressed air flow PA1 a swirling flow, a swirler structure may be disposed between the first air intake hole 25 and the first air injection hole 22. Alternatively, as schematically illustrated in FIG. 3A, flow passages 25a that provides communication between the first air intake hole 25 and an air flow passage 22a that extends to the first air injection hole 22 in an axial direction of the combustion nozzle 2 may be provided such that extending directions of the flow passages 25a are inclined with respect to a circumferential direction of the air flow passage 22a. In other words, the air flow passage 22a and the flow passages 25a are disposed such that the circumferential direction of the air flow passage 22a and each of the extending directions of the flow passages 25a form an acute angle. As a result, the compressed air flow PA1 may include an air flow component in the circumferential direction of the air flow passage 22a. After the compressed air flow PA1 is injected through the first air injection hole 22, a radial air flow component is weakened by the compressed air flow PA2, so that the compressed air flow PA1 spirally flows. To make the compressed air flow PA2, which flows outward of the compressed air flow PA1 in the radial direction of the combustion nozzle 2, a swirling flow, for example, the second air injection holes 23 may be disposed such that injection directions of the air injected through the second air injection holes 23 are inclined in a circumferential direction of the nozzle end surface 21 relative to the axial direction of the nozzle end surface 21. In this case, the presence of the combustion nozzles 2 configured such that flowing directions of the compressed air flow (and the fuel flow) are adjacently along an inner peripheral wall of the combustor 1 suppresses a radially outward component of the compressed air flows PA2, so that the compressed air flows PA2 become swirling flows, as illustrated in FIG. 3C.

### Modification Examples of Shapes of Air Injection Hole and Fuel Injection Hole

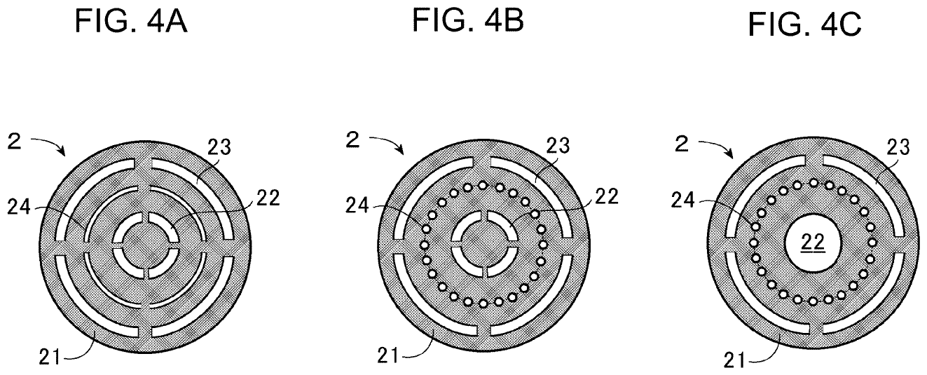

Some or all of the first air injection hole 22, the second air injection holes 23, and the fuel injection holes 24 disposed in the nozzle end surface 21 may have a slit shape as schematically illustrated in FIGS. 4A, 4B, and 4C. The fuel injection holes 24 have a width narrower than the quenching distance of the fuel to prevent flashback.

### Example of Combustion Nozzle Including Additional Air Injection Holes and Fuel Injection Holes

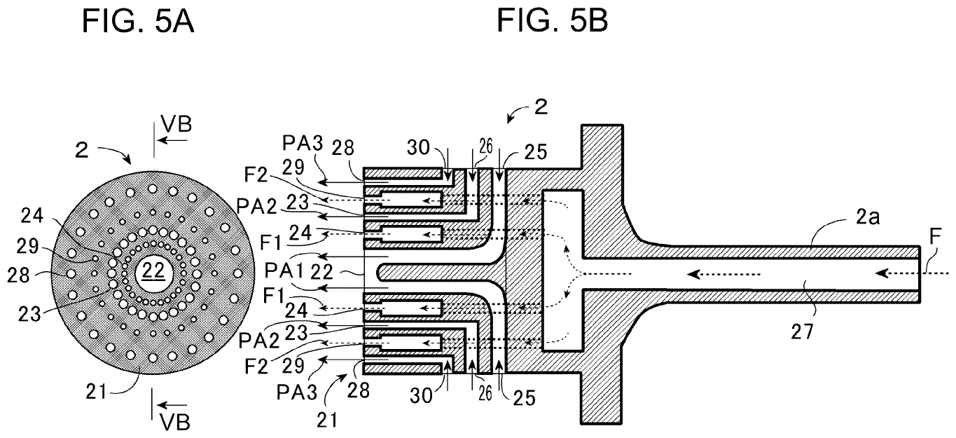

As illustrated in FIGS. 5A and 5B, the nozzle end surface 21 may include a plurality of third air injection holes 28 disposed circumferentially at positions radially outward of the second air injection holes 23 so as to surround the second air injection holes 23 such that a compressed air flow PA3 is generated adjacent to the compressed air flow PA2, and a plurality of second fuel injection holes 29 disposed circumferentially and interposed between the second air injection holes 23 and the third air injection holes 28 such that a second fuel flow F2 is injected into a space between the compressed air flow PA2 and the compressed air flow PA3. Even in such a configuration, the air injection holes may be formed such that at least one of the compressed air flows PA1, PA2, PA3 becomes a swirling flow. According to this configuration, the space where the fuel and the air contact each other increases, which accelerates mixing of the fuel and the air rapidly. Although they are not illustrated, additional fuel injection holes and air injection holes may be provided radially outward of the third air injection holes 28 in the same manner.

In this way, in the above-described configurations of the combustion nozzles and the combustors that include the combustion nozzles, since the fuel flow is sandwiched between the compressed air flows when the compressed air and the fuel are injected into the combustion field, the shear actions between the fuel flow and the compressed air flows allow the fuel and the compressed air to be mixed rapidly without blowing off the fuel flow in one direction. In such configurations, since the fuel and the compressed air are mixed immediately after being injected into the combustion field, the fuel is dispersed more evenly in the compressed air without requiring a space for premixing the fuel and the compressed air for combustion, unlike a conventional case. Thus, reduction in generation of NOx may be expected. In addition, since the fuel injection holes open to the combustion field each have an inner diameter smaller than the quenching distance of the fuel, a flashback phenomenon may also be prevented.

The configuration according to the embodiment is advantageously applied to a combustor for a gas turbine using hydrogen as fuel, in particular, for a small-sized gas turbine generating power output of, for example, several tens of kilowatts, and a combustion nozzle thereof. It is noted that the configuration in which the fuel injection holes each have an inner diameter smaller than the quenching distance of the fuel and are arranged circumferentially as illustrated in FIGS. 2A, 2B, and 2C is applicable to a combustor for a small-sized gas turbine that generates several tens of kilowatts because the number of the fuel injection holes in the combustion nozzle ranges from several tens to several hundreds. However, this configuration is impractical for a combustor for a gas turbine generating power output of, for example, several hundreds of kilowatts or several megawatts because the number of the fuel injection holes in the combustion nozzle could range from several tens of thousands to several millions.

The above descriptions are provided in relation to the embodiments of the disclosure. Persons skilled in the art may easily apply various modifications and changes to the above-described embodiments. It is apparent that the disclosure is not limited to the embodiments illustrated herein, but is applicable to various devices without departing from the scope of the disclosure.

1. A combustion nozzle configured to inject compressed air and fuel for combustion into a combustion chamber of a combustor for a gas turbine, the combustion nozzle comprising:
a first air injection hole through which a first air flow of the compressed air is injected into the combustion chamber;
a second air injection hole through which a second air flow of the compressed air is injected adjacent to the first air flow into the combustion chamber; and
a fuel injection hole through which a fuel flow of the fuel is injected into the combustion chamber at a flow velocity different from a flow velocity of the first air flow and a flow velocity of the second air flow in a state where the fuel flow is sandwiched between the first air flow and the second air flow, the fuel injection hole having an inner diameter smaller than a quenching distance of the fuel.

2. The combustion nozzle according to claim 1, wherein the fuel injection hole is disposed at a position circumferentially surrounding the first air injection hole, and the second air injection hole is disposed at a position circumferentially surrounding the first air injection hole and the fuel injection hole.

3. The combustion nozzle according to claim 1, wherein the first air injection hole and the second air injection hole are provided such that a flow direction of the first air flow and a flow direction of the second air flow are different from each other.

4. The combustion nozzle according to claim 1, wherein the first air injection hole and the second air injection hole are provided such that at least one of the first air flow and the second air flow becomes a swirling flow.

5. A combustor for a gas turbine, the combustor comprising a plurality of combustion nozzles arranged adjacent to each other and configured to inject compressed air and fuel for combustion into a combustion chamber, each of the combustion nozzles including:
a first air injection hole through which a first air flow of the compressed air is injected into the combustion chamber;
a second air injection hole through which a second air flow of the compressed air is injected adjacent to the first air flow into the combustion chamber; and
a fuel injection hole through which a fuel flow of the fuel is injected into the combustion chamber at a flow velocity different from a flow velocity of the first air flow and a flow velocity of the second air flow in a state where the fuel flow is sandwiched between the first air flow and the second air flow, the fuel injection hole having an inner diameter smaller than a quenching distance of the fuel,
wherein the fuel injection hole is disposed at a position circumferentially surrounding the first air injection hole, and the second air injection hole is disposed at a position circumferentially surrounding the first air injection hole and the fuel injection hole, and
wherein the first air injection hole and the second air injection hole are provided such that at least one of the first air flow and the second air flow becomes a swirling flow.

6. The combustion nozzle according to claim 2, wherein the first air injection hole and the second air injection hole are provided such that a flow direction of the first air flow and a flow direction of the second air flow are different from each other.

7. The combustion nozzle according to claim 2, wherein the first air injection hole and the second air injection hole are provided such that at least one of the first air flow and the second air flow becomes a swirling flow.
